(19) United States
(12) Patent Application Publication
(10) Pub. No.: US 2013/0309897 A1
(43) Pub. Date: Nov. 21, 2013

(54) PLUG-CONNECTOR WITH CAP-HOLDING MECHANISM

(71) Applicant: Francois Jodon De Villeroche, La Celle Saint Cloud (FR)

(72) Inventor: Francois Jodon De Villeroche, La Celle Saint Cloud (FR)

(73) Assignee: TYCO ELECTRONICS FRANCE SAS, Pontoise (FR)

(21) Appl. No.: 13/983,038

(22) PCT Filed: Jan. 24, 2012
(86) PCT No.: PCT/EP12/51031

§ 371 Date: Jul. 31, 2013

(30) Foreign Application Priority Data
Feb. 3, 2011 (FR) 1100339

(51) Int. Cl. H01R 13/52

(52) U.S. Cl. CPC H01R 13/52
USPC 439/345

(57) ABSTRACT

The present invention relates to an electrical plug-element for an electrical plug-in connector, comprising a conductor receiving section adapted to take up at least one electrical conductor, and a cap which in a fitted position (R) at least partly covers the conductor receiving section and/or the conductor. In order to securely hold the cap on the plug-element, the present invention provides a blocking member, which in a blocking position (B) blocks the cap in the fitted position (R).

The present invention relates to an electric plug-element for an electrical plug-in connector, especially for automotive application, as a through-hole connector for a car door, comprising a conductor receiving section adapted to take up at least one electrical conductor, and a cap, which in a fitted position at least partly covers the conductor receiving section and/or the conductor.

Plug-elements of the type described are above are known from the prior art. The plug-elements are connected to mating plug-elements which reach through holes in autobody or door sheets. As the plug-elements are thereby situated in gaps which may be exposed to deleterious environmental conditions, such as moisture and dirt, the conductor receiving sections, where the conductors are inserted into the plug-element, and the conductors themselves have to be sealed. Moreover, a mechanical protection of the plug-elements and the conductors is desirable. For sealing and protecting the plug-element and the conductors, the cap is utilised.

Furthermore, especially as car doors are frequently moved, the plug-element including the cap as well as the conductors may undergo mechanical stresses. The mechanical stresses may tend to tear at the conductor, the cap and/or the conductor receiving section. Hence, the connections between the conductor, the cap and/or the conductor receiving section are prone to be weakened or even interrupted over time. However, when the cap is removed from its fitted position, i.e. at least partly detached from the plug-element, the mentioned moisture and dirt may enter the plug-element and may thereby cause corrosion and short circuits.

In view of the problems of the prior art described above, an object underlying the invention is to provide a plug-element wherein the cap is securely fixed in the fitted position.

This object is achieved according to the present invention in that a blocking member is provided, which in a blocking position blocks the cap in the fitted position.

This solution provides that the cap may be irremovably arrested at the plug-element, thereby being reliably positioned for protecting and sealing up the conductor receiving section and/or the conductor.

The solution according to the invention can be combined as desired and further improved by the following further embodiments that are advantageous on their own in each case:

According to a first possible further embodiment, the cap may be fitted on to the conductor receiving section in a fitting direction and the fitted position may overlap with the conductor receiving section at an overlapping zone in a projection against the fitting direction, wherein in the blocking position the blocking member may inhibit a movement of the cap perpendicularly to the fitting direction. Thereby, the cap may be easily blocked in the fitted position such that it may not be pulled off the conductor receiving section against the fitting direction. In other words, the cap and/or the conductor receiving section may be provided with interacting lugs, protrusions and/or recesses which may interleave in the fitted position, such that they overlap in and/or against the fitting direction. Disengaging the cap and the conductor receiving section may be prevented by blocking movements of any of the overlapping elements with the help of the blocking member.

For easily attaching the cap to the plug-element, it may be provided that the cap and the conductor receiving section are latched with each other in the fitted position. By being latched, the cap and the conductor receiving section overlap as described above. The overlapping may be further improved in that the overlapping zone extends along an outer circumference of the conductor receiving section and/or along an inner circumference of an opening of a cap. Thereby, the cap may snugly encompass the conductor receiving section or vice versa.

According to a further possible embodiment of the present invention, the blocking member may be connected to a locking device of the plug-element for locking the plug-element in a fully mated state, where the plug-element is fully mated with a mating plug-element of the electrical plug-in connector. Thereby, the actuation of the blocking member and the locking device, which is also often called connector positioning assurance (CPA), may be combined, which facilitates handling the plug-in connector. Further, by connecting the blocking member to the locking device, the blocking member and/or the locking device may be undetachably connected to the plug-element whereby they may not get lost so easily and a match of the blocking member, the locking device and the plug-element is assured.

The functionality of the blocking member and the locking device may be further combined in order to facilitate the handling of the plug-element in that the blocking member may be moveable from a pre-blocking position, where the locking device is in a pre-locking position, to the blocking position, where the locking device is in a locking position. Thereby, on the one hand, reaching the blocking position assures that the locking position is reached which signalises a proper mating of the plug-in connector. On the other hand, in case the blocking position may not be reached for whatever reason, the plug-in connector may not be locked which helps to prevent and signalise premature and/or false mating of the plug-in connector.

According to another further embodiment of the present invention, the locking device may be adapted to engage with both the plug-element and the mating plug-element in a pre-mated state of the plug-in connector in order to exert a plug force by actuating the blocking member and/or the locking device. Thereby, any forces for actuating the blocking member and/or the locking device may be used, i.e. transferred, in order to overcome insertion forces when mating the plug-in connector.

The forces actuating the blocking member and/or the locking device may be transferred to plug-forces for overcoming the insertion forces in that the plug-element may be provided with a guidance for slidably guiding the locking device essentially perpendicularly to a plug-in direction of the plug-element. By the sliding movement, at least one further guidance formed at the locking device and running in a slant or bevelled manner with respect to the plug-in direction may be used to engage with elements formed at the mating plug-element such that these elements may be pulled towards the plug-element when the locking device is slid perpendicularly to the plug-in direction.

According to a further possible embodiment, the blocking member may be attached pivotable to the plug-element. Thereby, the blocking member may be easily moved from the pre-blocking position to the blocking position and may be undetachably connected to the plug-element. Further, pivoting the locking member may facilitate exerting any plug-forces on the plug-element because the blocking member is moved along a pre-defined actuating way.

Further, the blocking member may be attached to the plug-element via a slotted link. The slotted link may be formed at the locking device. Especially, when the blocking member is attached pivotably to the conductor receiving section is at the same time connected to the locking device via the slotted link, an interaction of the blocking member and the locking device as described above is easily achieved. Hence, the blocking member is may form an actuating level for closing the plug-in connector.

For securing the blocking member in the fitted position and/or signalising its arrival at the fitted position, it may be provided that the blocking member has a latching element which may be adapted to engage with a counter latching element at the plug-element in the blocking position. At the same time, the locking device may be provided with a latching element which may engage the counter latching element at the plug-element in the locking position. Thereby, securing the locking device in the locking position may be enabled.

According to another further embodiment of the present invention, it may be provided that the blocking member is formed as a cover which, in the blocking position, at least partly covers the cap. Thereby, the cap may be shielded especially from mechanical impacts. This may be desirable when it is provided that the cap has a higher resiliency than the conductor receiving section. Through its higher resiliency, the cap may snugly fit on the conductor receiving section and/or the conductor in order to seal up the conductor receiving section and/or the conductor and at the same time allow for movements of the conductor with respect to the conductor receiving section.

According to a further possible embodiment of the present invention, it may be provided that the cap has a fitting portion and a conductor guiding section, wherein the fitting portion and the conductor guiding section are angled with respect to each other. Thereby, the conductor may be guided at a certain angle away from the plug-element. This helps to keep the overall dimensions of the plug-element and the conductor small, i.e. preferably flat in the plug-in direction, which is especially advantageous when the plug-in connector is used in narrow spaces such as the gaps at the above-mentioned car doors.

The invention will be described in more detail by way of example hereinafter with reference to the accompanying drawings which illustrate advantageous embodiments. The described embodiments are only possible configurations in which the individual features may however, as described above, be implemented independently of each other or be omitted. Corresponding elements illustrated in the drawings are provided with the same reference signs. Parts of the description relating to the same elements in different drawings are omitted.

In the drawings:

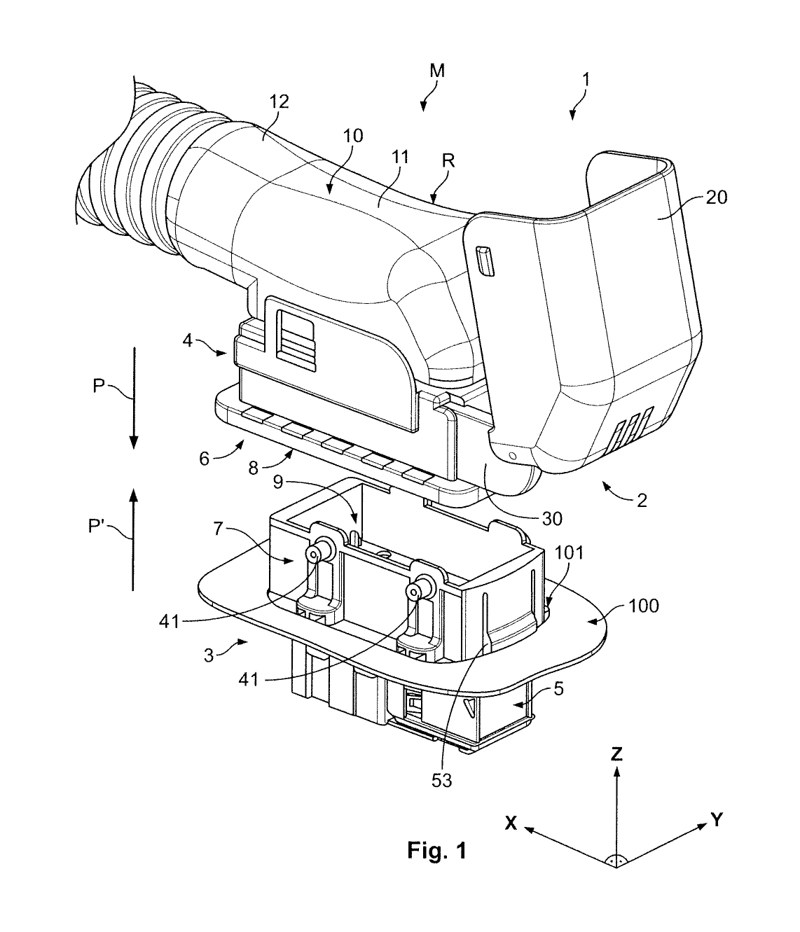

FIG. 1 is a schematic perspective view of a plug-in connector according to the present invention in a ready to merge position;

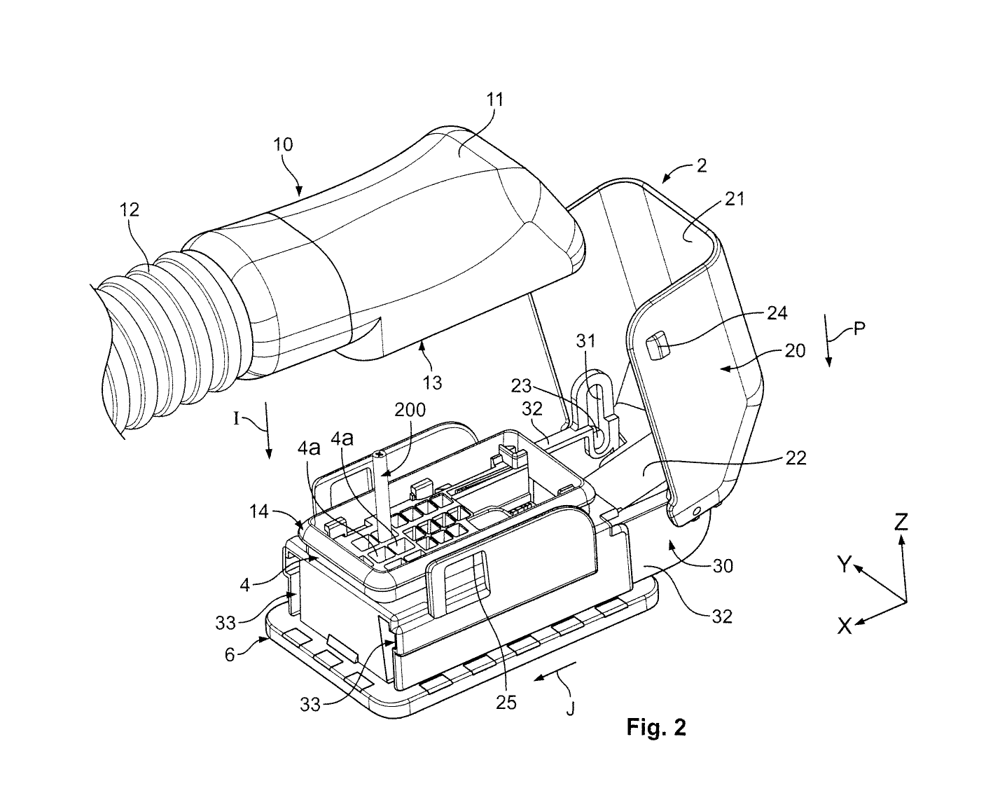

FIG. 2 is a schematic perspective view of a plug-element according to the present invention with a cap ready to be fitted onto the conductor receiving section;

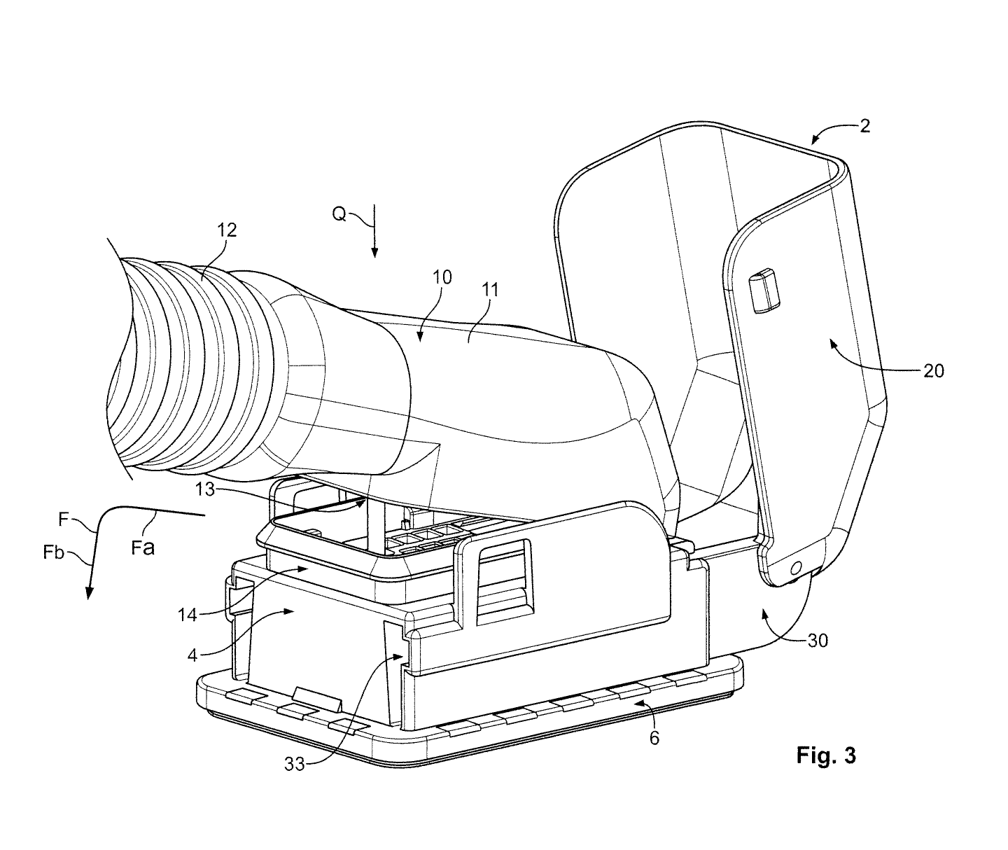

FIG. 3 is a schematic perspective view of the plug-element shown in FIG. 2 with the cap half fitted onto the conductor receiving section;

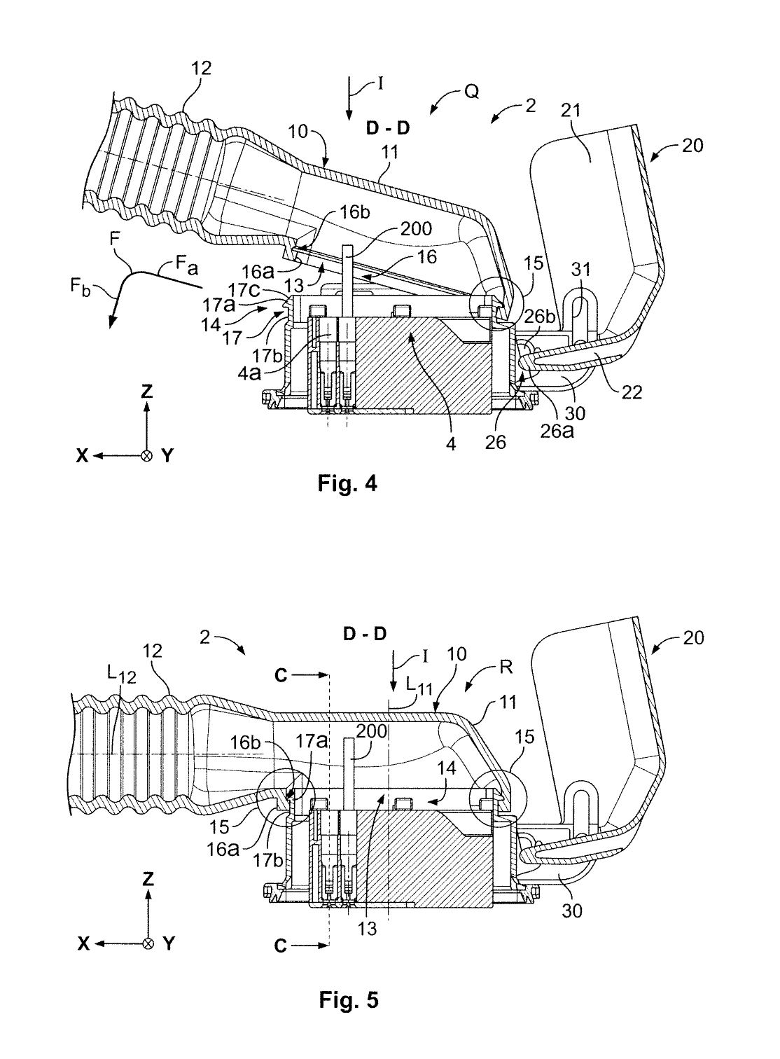

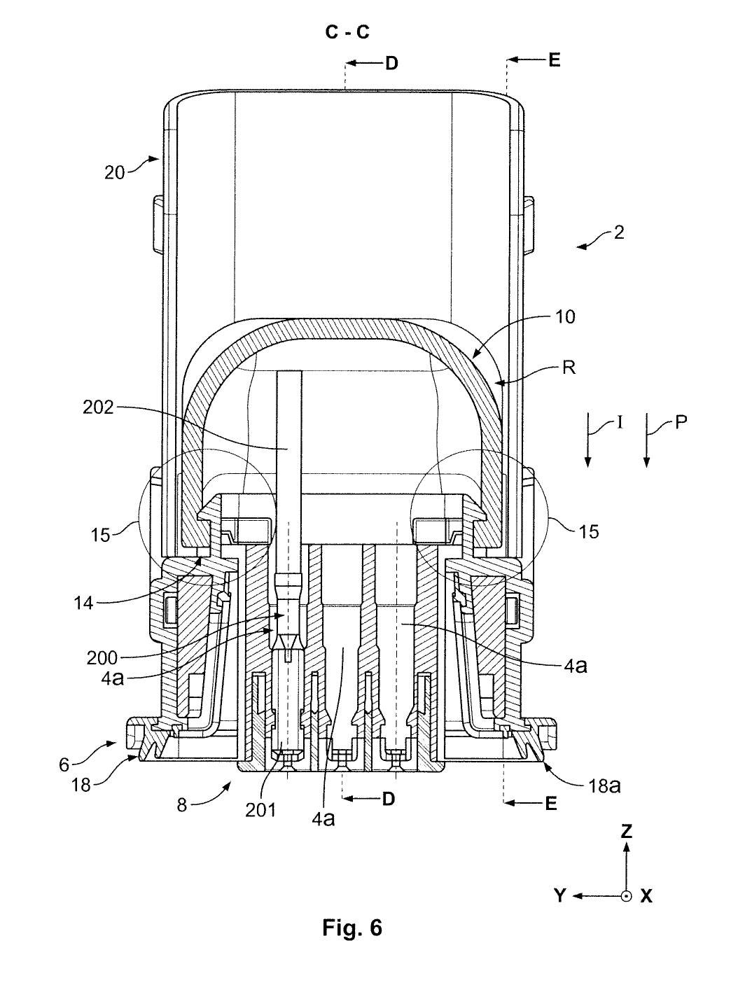

FIG. 4 is a schematic cross-sectional view of the plug-element shown in FIG. 3 along the cross-sectional line D-D depicted in FIG. 6;

FIG. 5 is a schematic cross-sectional view of the plug-element shown in FIGS. 2 to 4 along the cross-sectional line D-D depicted in FIG. 6 with the cap in the fitted position;

FIG. 6 is a schematic cross-sectional view of the plug-element shown in FIG. 5 along the cross-sectional line C-C depicted in FIG. 5;

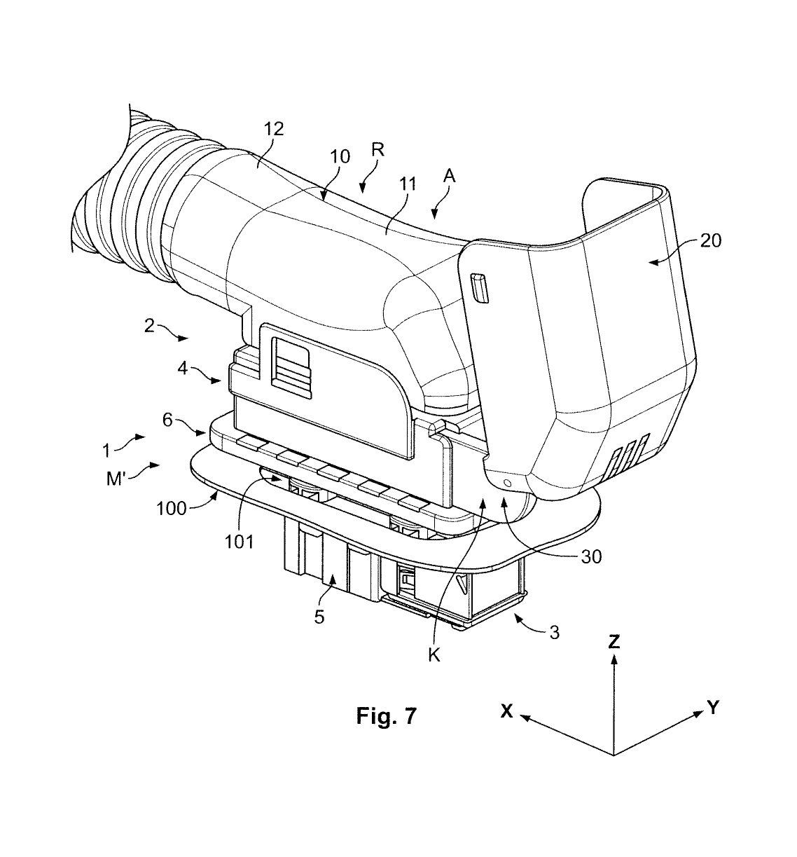

FIG. 7 is a schematic perspective view of the plug-in connector shown in FIG. 1 in a pre-mated state;

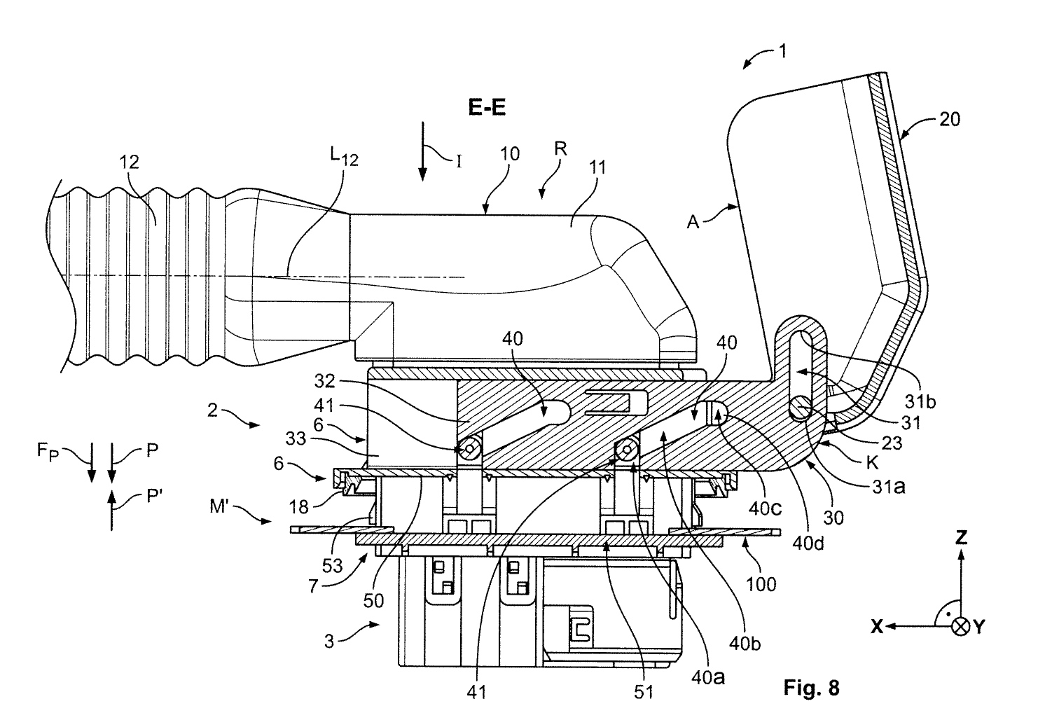

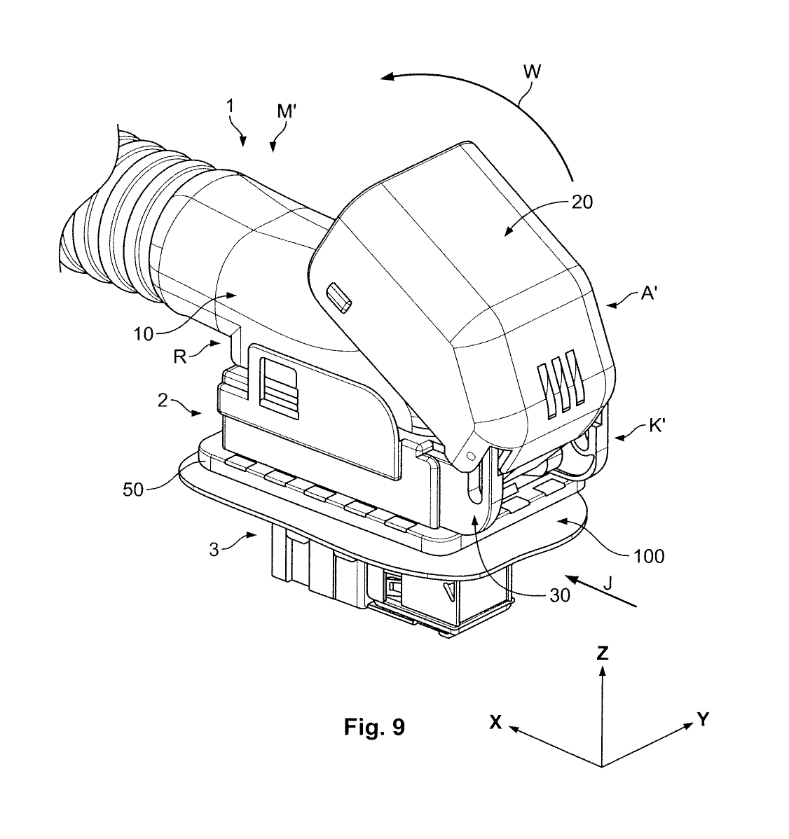

FIG. 8 is a schematic cross-sectional view of the plug-in connector in the pre-mated state as shown in FIG. 7 along the cross-sectional line E-E depicted in FIG. 6;

FIG. 9 is a schematic perspective view of the plug-in connector shown in FIGS. 1, 7 and 8 in a pre-mated state;

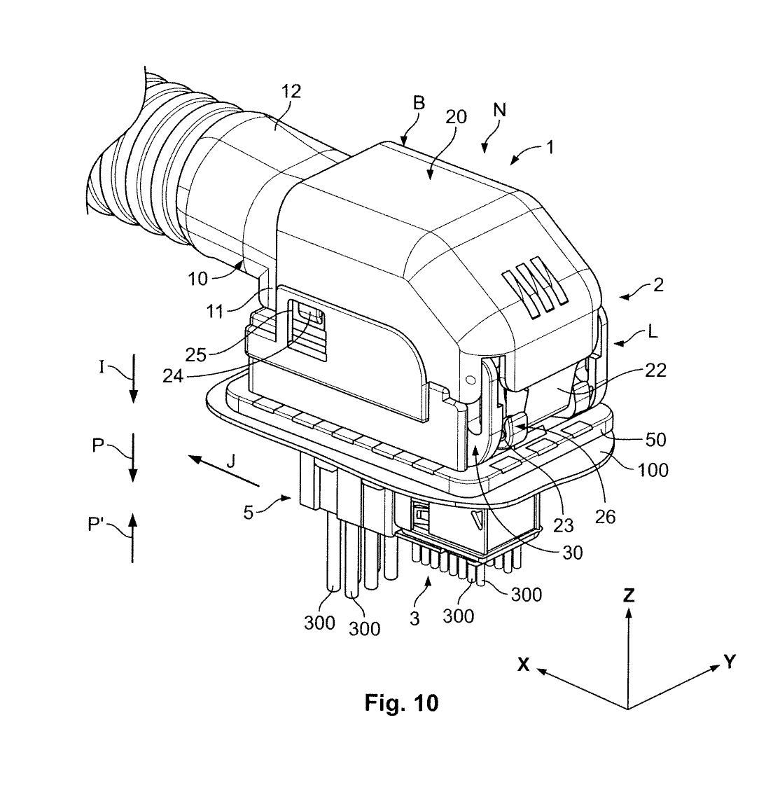

FIG. 10 is a schematic perspective view of the plug-in connector shown in FIGS. 1 and 7 to 9 in a fully-mated state;

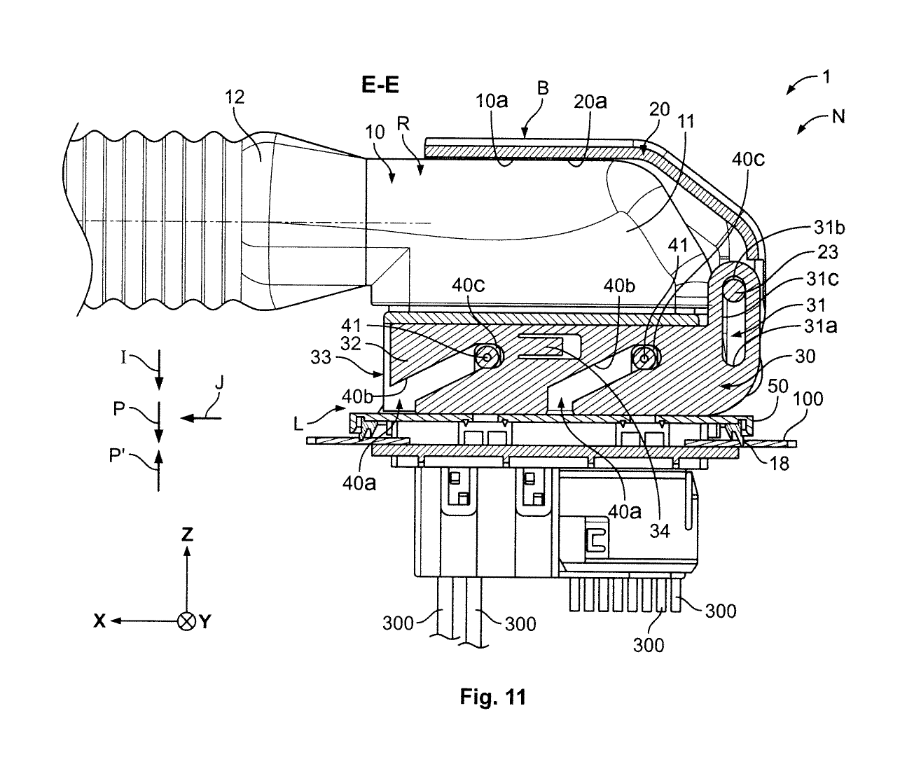

FIG. 11 is a schematic cross-sectional view of the plug-in connector shown in FIGS. 1 and 7 to 10 along the cross-sectional line E-E depicted in FIG. 6;

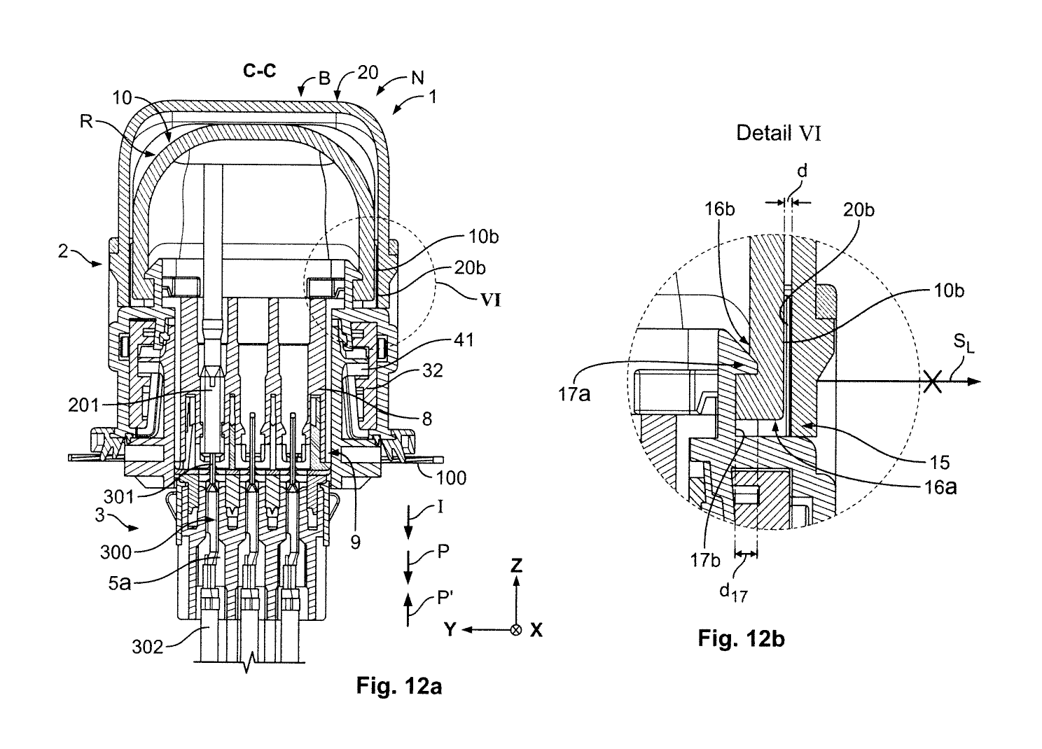

FIG. 12a is a schematic cross-sectional view of the plug-in connector shown in FIGS. 1 and 7 to 11 in the fully-mated state along the cross-sectional line C-C depicted in FIG. 5;

FIG. 12b is a detail VI depicted in FIG. 12a;

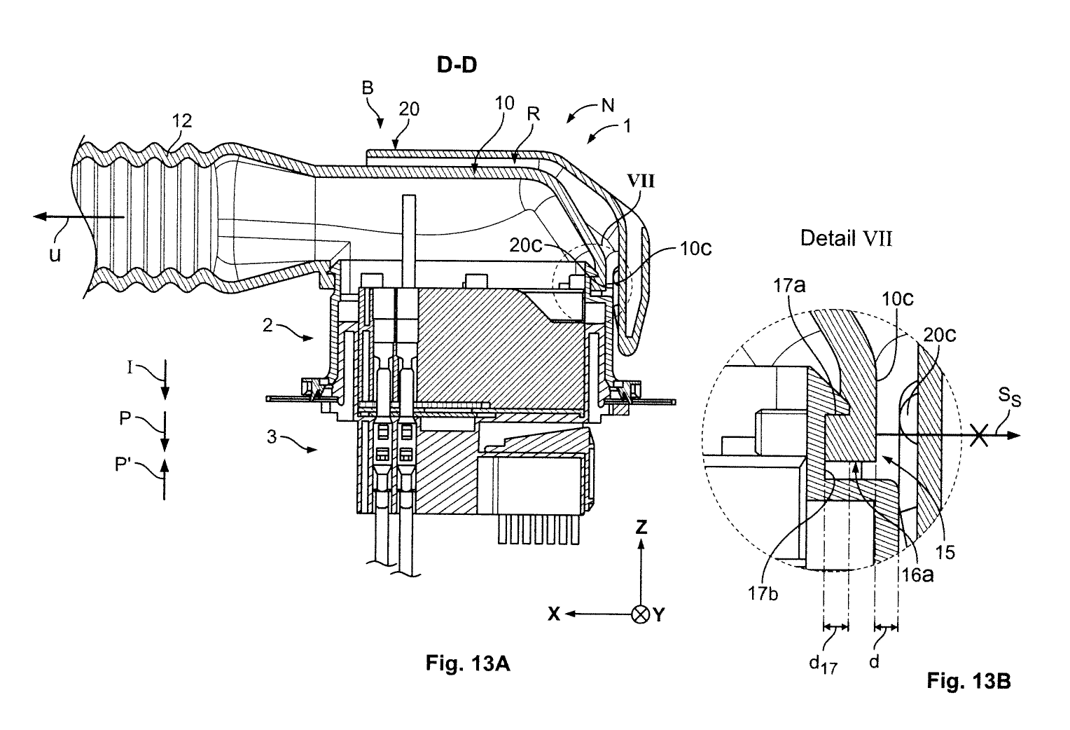

FIG. 13a is a schematic cross-sectional view of a plug-in connector according to the present invention in the fully-mated state along the cross-sectional line D-D depicted in FIG. 6;

FIG. 13b is a schematic view of detail VII depicted in FIG. 13a;

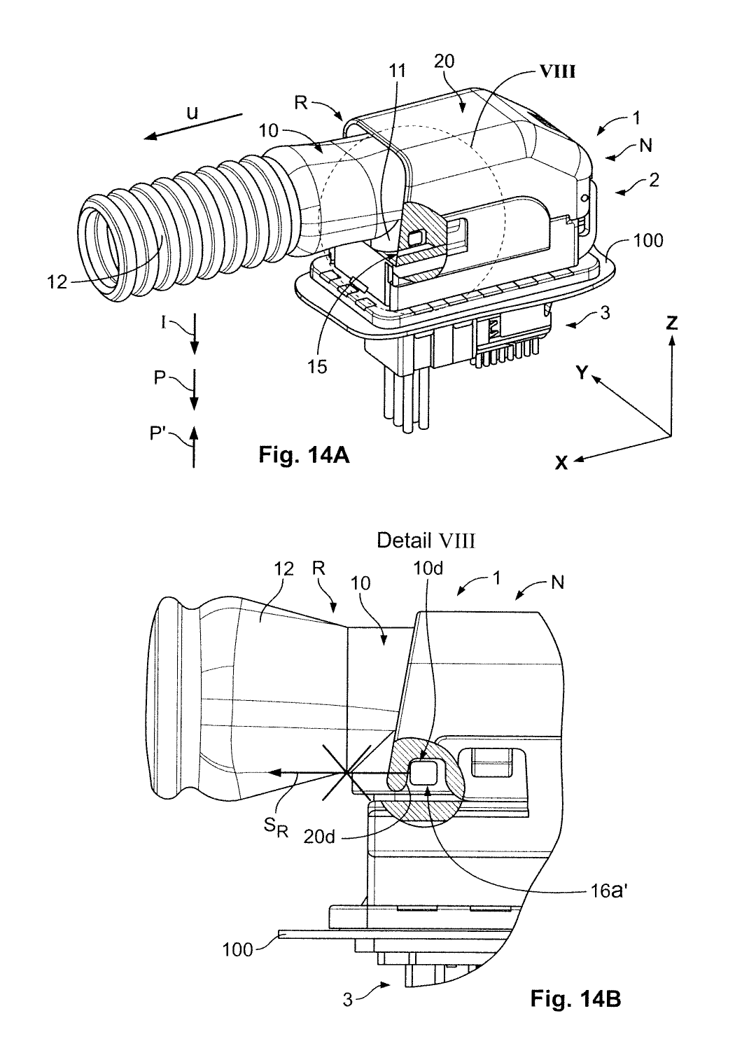

FIG. 14a is a schematic perspective view of a plug-in connector according to the present invention in the fully-mated state with a cross-section made partly in the area of a rear blocking zone; and

FIG. 14b is a detail VIII depicted FIG. 14a

As shown in FIG. 1, a plug-in connector 1 according to an embodiment of the present invention may comprise a plug-element 2 and a mating plug-element 3, each according to an embodiment of the present invention. The plug-element 2 comprises a conductor receiving section 4 which is adapted to receive at least one electrical conductor (not yet shown). Analogously, the mating plug-element 3 comprises a mating conductor receiving section 5, which is adapted to receive at least one mating electrical conductor (not yet shown).

The plug-element 2 comprises a plug portion 6 which is adapted to be merged with a mating plug portion 7 of the mating plug-element 3. Therefore, the plug portion 6 is formed as a plug 8 and the mating plug portion 7 provides a receptacle 9 for the plug 8. The receptacle 9 opens towards a plug-direction P. The plug-direction P extends in parallel to a height direction Z of the plug-in connector 1. Further, the plug-in connector 1 extends along a length direction X and a width direction Y, running perpendicularly to each other as well as to the height direction Z.

Moreover, FIG. 1 shows a wall portion 100 which may be a piece of metal sheet material forming a part of a car body or door. The wall portion 100 provides a through hole 101, an inner contour of which is adapted to an outer contour of the mating plug-element 3. The mating plug portion 7 is pushed through the through hole 101 in a mating plug-direction P′ running in parallel and contrarywise to the plug-direction P.

FIG. 2 shows the plug-element 2 in a schematic perspective view. The plug-element 2 comprises or is provided with a cap 10 for covering and protecting the conductor receiving section 4 and any conductors 200 arranged therein, wherein the conductors may comprise electrical terminals (not yet shown) as well as electrical lines attached thereto. The conductors 200 are held in conductor receptacles 4a formed in conductor receiving section 4 and running essentially in parallel to the height direction Z. The cap 10 comprises a fitting portion 11 and a conductor guiding section 12. The fitting portion 11 is provided with an opening 13 which may be fitted onto a cap holding section 14 formed at the conductor receiving section 4 in a fitting direction I running in parallel to the height direction Z.

Further, the plug-element 2 comprises a blocking member 20 which provides a cover 21 for the cap 10. The blocking member 20 is pivotably attached to the plug-element 2 via a lever 22 and studs 23 engaging with a locking device 30 of the plug-in connector 1. The studs 23 are guided within slotted links 31 formed at the locking device 30 and running in parallel to the height direction Z. The blocking member 20 is provided with a latching element 24 adapted to engage with a counter latching element 25 formed at the plug-element 2. The latching element 24 is formed as a lug or detent and the counter latching element 25 is formed as an opening or recess. The locking device 30 is further provided with guide rails 32 which are each slidably guided in a guidance 33 formed at the plug-element 2 such that the locking device 30 may be slid in and against a locking direction J running in parallel to the length direction X and perpendicularly to the plug-direction P.

FIG. 3 shows the plug-element 2 in another schematic perspective view. The cap 10 is in a half-fitted position Q wherein it is partly fitted onto the cap-holding section 14. According to an inventive method for fitting the cap 10 on the cap-holding section 14, a side of the opening 13 adjacent to the blocking member 20 is seated on the cap-holding section 14 and then pulled by a pulling force Fₐ before being pushed with a pushing force F_{b}. The pulling force Fₐ and the pushing force F_{b} are combined to a fitting movement F for fitting the cap 10 onto the conductor receiving section 4.

FIG. 4 is a schematic cross-sectional view of the plug-element 2 with the cap 10 in the half-fitted position Q along the cross-sectional line D-D depicted in FIG. 6. In the half-fitted position Q, in an overlapping zone 15, an inner circumference or contour 16 of the opening 13 overlaps with an outer circumference or contour 17 of the cap-holding section 14. The inner contour 16 is formed by an inner rim 16a and an inner notch 16b. The outer contour 17 is formed by an outer rim 17a and an outer notch 17b. The outer rim 17a is provided with a bevel 17c towards the fitting direction I in order to facilitate fitting the cap 10 onto the conductor receiving section 4.

Further, it becomes apparent in FIG. 4 that a pin 26a formed at the lever 22 engages with a socket 26b formed at the plug-element 2 so that the pin 26a and the socket 26b together form a pivot joint 26 about which the blocking member 20 may be pivoted.

FIG. 5 shows the plug-element 2 equipped with the cap 10 in a fitted position R. In the fitted position R, the inner rim 16a formed at the cap 10 is seated within the outer notch 17b formed at the cap-holding section 14. The outer rim 17a of the cap holding section 14 sits within the inner notch 16b formed at the cap 10. Hence, the inner contour 16 overlaps with the outer contour 17 in a projection along the fitting direction I. In detail, the inner rim 16a is located below the outer rim 17a, i.e. behind the outer rim 17a in the fitting direction I. The outer rim 17a interleaves with the inner contour 16 in the area of the inner notch 16b. In other words, the inner contour 16 is partly situated above the outer rim 17a, i.e. in front of the outer rim 17a in the fitting direction I.

Further, FIG. 5 shows that a longitudinal axis L₁₁ of the fitting portion 11 extending through the opening 13 runs essentially in parallel to the height direction Z as well as the insertion direction I and therefore perpendicularly to a longitudinal axis L₁₂ of the conductor guiding section 12 running essentially in parallel to the length direction X. Hence, the fitting portion 11 is angled with respect to the conductor guiding section 12.

FIG. 6 shows the plug-element 2 in a schematic cross-sectional view along the cross-sectional line C-C depicted in FIG. 5 with the cap 10 in the fitted position R. Here it becomes apparent that the overlapping zone 15 also extends along the length direction X. Hence, the overlapping zone 15 circumferentially encompasses the plug-element 2 where the cap 10 is seated onto the cap holding section 14.

Further, FIG. 6 shows that the conductor 200 comprises a terminal 201 which is located within one of the conductor receptacles 4a. The terminal 201 is formed as a receptacle for a contact pin (not yet shown). The terminal 201 is connected to an electrical line 202 extending through the conductor receptacle into the cap 10. The plug portion 6 is further provided with a sealing 18 having lamellas 18a which protrude from the plug portion 6 in the plug-direction P in order to seal up the plug-element 2 against the wall portion 100.

FIG. 7 shows the plug-in connector 1 with its plug-element 2 and mating plug-element 3 in a pre-mated state M′, wherein the plug-element 2 is halfway merged with the mating plug-element 3, which is seated within the through hole 101 of the wall portion 100. The cap 10 is in the fitted position R. The blocking member 20 is in a pre-blocking position A wherein it does not yet block the cap 10 in its fitted position R. The locking device 30 is in a pre-locking position K, wherein the locking device 30 does not yet lock the plug-in connector 1.

In FIG. 8, the plug-in connector 1 is shown in a schematic cross-sectional view along the cross-sectional line E-E depicted in FIG. 6. Here, the plug-in connector 1 is in the same state as shown in FIG. 7. That is, the plug-element 2 and the mating plug-element 3 are in a pre-mated state M′. The cap 10 is in the fitted position R. The blocking member 20 is in the pre-blocking position A. The locking device 30 is in the pre-locking position K. The stud 23 and the blocking member 20 are located at a lower end 31a of the slotted link 31. The lower end 31a is located opposite to an upper end 31b of the slotted link 31.

Locking elements 40 of the plug-element 2, in particular of the locking device 30, engage with counter locking elements 41 formed at the mating plug-element 3. The locking elements 40 are formed as slotted links which each have an opening 40a which opens in the plug-direction P. A guidance 40b of each of the locking elements 40 is connected to the opening 40a and extends in a slanted manner with respect to the length direction X and in the height direction Z in order to exert a plug force Fₚ pulling the plug-element 2 towards the mating plug-element 3 when pushing the locking device 30 in the locking direction J. The guidance 40b leads into a locking zone 40c, where the guidance runs parallel to the length direction X, i.e. perpendicularly to the plug-direction P and the mating plug-direction P′. At an end of the guidance 40b, the locking zone 40c is provided with a limit stop 40d for the counter locking element 41.

Further, the plug portion 6 is provided with a base 50 holding the sealing element 18 and extending essentially in parallel to the length direction X and the width direction Y. A mating base 51 formed at the mating plug portion 7 extends essentially along the length direction X and the width direction Y and is seated from below at the wall portion 100. In order to hold the mating base 51 at the wall portion 100, holding elements 53 in the form of detents are snapped behind the wall portion 100. Hence, the holding elements 53 sit above the wall portion 100 and the mating base 51 sits below the wall portion 100, whereby the mating plug-element 3 is held firmly in the through hole 101 of the wall portion 100.

FIG. 9 shows another schematic perspective view of the plug-in connector 1 in the pre-mated state M′. Here, the blocking member 20 is about to be transferred from the pre-blocking position A into a blocking position (not yet shown) along an actuating way W of the blocking member 20. At the same time, the locking device is being moved from the pre-locking position K to a locking position (not yet shown) by being slid in the locking direction J while remaining in a semi-locking position K′.

FIG. 10 is a schematic perspective view of the plug-in connector 1 in the fully-mated state N. The blocking member 20 is moved along the actuating way W into its blocking position B. The latching element 24 of the blocking member 20 engages with the counter latching element 25, i.e. the detent 24 is snapped behind the opening 25 in the plug direction P. The cap 10 is held by the blocking member 20 such that any movements of the cap 10 against the fitting direction I are inhibited. The locking device 30 is moved along the locking direction J into its locking position L. In the locking position L, the locking device 30 locks the plug-element 2 and the mating plug-element 3 in the fully-mated state N. Further, the mating conductor receiving section 5 is provided with mating conductors 300.

FIG. 11 is a schematic cross-sectional view of the plug-in connector 1 in the fully-mated state N along the cross-sectional line E-E depicted in FIG. 6. This cross-section is made essential in a plane spanning in parallel to the length direction X and the height direction Z through the guide rail 32 of the locking device 30.

An upper blocking zone 20a defined by a ceiling of the blocking member 20 abuts or lies at least adjacent or in the vicinity to an upper edge 10a of the cap 10, thereby blocking the cap 10 in the fitted position R. The counter locking elements 41 have moved along their respective guidances 40b and are now situated in their respective locking zones 40c. Hence, the plug-element 2 and the mating plug-element 3 are locked in the fully-mated state N. In order to keep the locking device 30 arrested in the locking position L, a latching member 34 formed at the locking device 30 is snapped behind a counter latching member (not shown) in the guidance 33 such that movements of the locking device against the locking direction J are blocked by being moved along their respective guidances 40b. The counter locking elements 41 pull the plug-element 2, in particular the locking device 30 in the plug direction P, as the guide rails 32 are immobilized in their respective guidances 33 in and against the plug direction P.

Driving the locking device 30 in the locking direction J is facilitated in that along the actuating way W of the blocking member 20, the stud 23 moves from the lower end 31a of the slotted link 31 to the upper end 31b of the slotted link 31 while pushing against an actuating surface 31c supported by a side wall of the slotted link 31 and extending essentially in parallel to the height direction Z, the plug direction P and the mating plug direction P′. Further, in the fully-mated state N, the sealing element 18 is pressed between the base 50 and the upper side of the wall portion 100 such that it seals up the plug-in connector 1.

FIG. 12a is a schematic cross-sectional view of the plug-in connector 1 in the fully-mated state N along the cross-sectional line C-C depicted in FIG. 5. Here it becomes apparent that the blocking member 20 provides a lateral blocking zone 20b which abuts or at least lies adjacent to or in the vicinity of a lateral edge 10b of the cap 10. Hence, lateral movements, i.e. movements of the cap 10 in parallel to the width direction Y are inhibited.

Further, the plug 8 of the plug-element 2 is located within the receptacle 9 of the mating plug-element 3. The terminal 201 of the plug-element 2 engages with a mating terminal 301 sitting in a mating conductor receiving section 5a of the mating plug-element 3. The mating terminal 301 is connected to a mating electrical line 302 of the mating conductor 300.

FIG. 12b shows the detail VI depicted in FIG. 12a. Here it becomes apparent that a distance d measured in parallel to the width direction Y between the lateral edge 10b of the cap 10 and the lateral blocking zone 20b of the blocking member 20 is smaller than a depth d₁₇ of the outer notch 17b. Hence, the inner rim 16a of the cap 10 cannot slip from the outer rim 17a of the conductor receiving section 4 when the cap 10 is pulled against the fitting direction I. A lateral movement S_{L} of the cap 10 is inhibited.

FIG. 13a is a schematic cross-sectional view of the plug-in connector 1 in the fully-mated state N along the cross-sectional line D-D depicted in FIG. 6. In its blocking position B, the blocking member 20 provides a front blocking zone 20c in the form of a cam or rim which abuts or lies at least adjacent to or in the vicinity of a front edge 10c of the cap 10. Hence, when the cap 10, in particular the conductor guiding section 12 is pulled in a pulling direction U running in parallel to the length direction X, the inner rim 16a may not slip from the outer rim 17a and out of the notch 17b.

FIG. 13b shows the detail VII depicted in FIG. 13a. Here it becomes apparent that in the overlapping zone 15, the distance d measured between the front edge 10c of the cap and the front blocking zone 20c is again smaller than the depth d₁₇. Hence, front movements S_{S} of the cap 10 are inhibited and the cap is blocked in its fitted position R.

FIG. 14a is a schematic perspective view of the plug-in connector 1 in the fully-mated state N with the cap 10 in the fitted position R. This view is partly cross-sectioned in a rear section of the overlapping zone 15.

FIG. 14b shows the detail VIII depicted in FIG. 14a as can be seen in the cross-sectioned area, a rear edge 10d of the cap 10 may be formed in the overlapping zone 15 and/or at an additional rim 16a′. In the fully-mated state N, a rear blocking zone 20d formed at the blocking member 20 may overlap with the rear edge 10d in a projection along a rear movement S_{R} which runs essentially in parallel to the pulling direction U. Hence, the rear edge 10d abuts or at least lies in the vicinity to the rear blocking zone 20d such that the rear movement S_{R} is inhibited or at least limited and the cap 10 is blocked in the fitted position R.

Deviations from the above-mentioned embodiments of the present invention are possible without departing from the inventive idea: The plug-in connector 1 may comprise any desired number of mateable plug-elements 2 and mating plug-elements 3 which may be provided with a desired number of conductor receiving sections 4, conductor receptacles 4a, mating conductor receiving sections 5, mating conductor receptacles 5a, plug portions 6, mating plug portions 7, plugs 8, receptacles 9, and caps 10.

The cap 10 may be shaped as desired such that it may provide upper, lateral and front edges 10a-d, fitting portions 11, conductor guiding sections 12 and openings 13. The fitting portion 11 may be angled with the respect to the conductor guiding section 12 as shown herein at an angle of preferably 90°. However, other angles such as essentially 45° or 180° are also possible. The opening 13 of the cap 10 may be shaped however desired in order to interleave with the plug-element 2 and the cap-holding section 14. Hence, the overlapping zone 15 may be provided with inner contours, rims, notches 16, 16a, 16a′, 16b as well as outer contours, rims, notches 17, 17a, 17b, as desired for letting the cap 10 engage with the plug-element 2, in order to protect and seal the conductor receiving section 4. For sealing the plug-element 2 with respect to the wall portion 100, any desired number and shape of sealing elements with lamellas 18a may be provided.

The blocking member 20 may be shaped however desired in order to provide upper, lateral, front and rear blocking zones, 20a-d, as well as to provide a cover 21 and a lever 22. The blocking member 20 may either be connected with the locking device 30 via studs 23 and pivot joints 26 or may be connected directly to a housing of the plug-element 2, wherein the housing may comprise at least one of the conductor receiving sections 4 and the plug portion 6. The pivot joint 26 may comprise pins 26a and sockets 26b in whatever form desired in order to enable a pivoting of the blocking member 20. However, pivoting the blocking member 20 is not obligatory. As an alternative the blocking member 20 may also be designed such that it may be transferred from the pre-blocking position A to the blocking position B in a translatory movement. For locking the blocking member 20 in the blocking position B, the blocking member 20 may be provided with latching elements 24 adapted to engage with counter latching elements 25 in whatever shape and number desired.

The locking device 30 may be provided with slotted links 31 having lower and upper ends 31a, 31b as well as actuating surfaces 31c in whatever form and shape desired for guiding the blocking member 20. However, the slotted link 31 may also be formed at the housing of the plug-element 2. Further, it is not obligatory to slide the locking device 30 from the pre-locking position K into the locking position L. As an alternative, the locking device 30 may also be pivoted, for example. In order to fix the locking device 30 in the locking position L, the locking device 30 may be provided with latching members 34 in whatever form or number desired.

The locking elements 40 and respective counter locking elements 41 may be formed as desired in order to lock the plug-in connector 1 in a locking position L and/or exert a plug force in/or against the plug direction P as well as the mating plug direction P′. As an alternative to the slotted lever or slotted link mechanism provided by the locking element 40 with the opening 40a, the guidance 40b, the locking zone 40c and the limit stop 40d described herein, the locking element 40 and the counter locking element 41 may e.g. be formed as interacting gears which may pull the plug-in connector 1 into the fully-mated state N as well as lock it therein. It is however desired that the locking device 30 is provided with a limit stop 40d in order to be arrested in the locking position L being blocked between the latching member 34 and the limit stop 40d.

Finally, the base 50, the mating base 51 and the holding element 53 may be formed however desired for holding the plug-element 2 and/or the mating plug-element 3 in the through hole 101 of the wall portion 100, or as an alternative letting the plug-element 2 snugly abut the mating plug-element 3 without a wall portion 100 therebetween.

1-15. (canceled)

16. Electrical plug-element for an electrical plug-in connector, comprising a conductor receiving section adapted to take up at least one electrical conductor, and a cap which in a fitted position (R) at least partly covers the conductor receiving section and/or the conductor, wherein a blocking member is provided, which in a blocking position (B) blocks the cap in the fitted position (R).

17. Electrical plug-element according to claim 16, wherein the cap is fitted onto the conductor receiving section in a fitting direction (I) and in the fitted position (R) overlaps with the conductor receiving section at an overlapping zone in a projection against the fitting direction (I), and in that in the blocking position (B) the blocking member inhibits a movement of the cap perpendicularly to the fitting direction (I).

18. Electrical plug-element according to claim 16, wherein the cap and the conductor receiving section are latched with each other in the fitted position (R).

19. Electrical plug-element according to claim 17, wherein the overlapping zone extends along an outer circumference of the conductor receiving section and/or along an inner circumference of an opening of the cap.

20. Electrical plug-element according to claim 16, wherein the blocking member is connected to a locking device of the plug-element for locking the plug-element in a fully mated state (N) where the plug-element is fully mated with a mating plug-element of the electrical plug-in connector.

21. Electrical plug-element according to claim 20, wherein the blocking member is movable from a pre-blocking position (A), where the locking device is in a pre-locking position (K), to the blocking position (B), where the locking device is in a locking position (L).

22. Electrical plug-element according to claim 20, wherein the locking device is adapted to engage with both, the plug-element and the mating plug-element in a pre-mated state (M′) of the plug-in connector in order to exert a plug force (Fₚ) by actuating the blocking member and/or the locking device.

23. Electrical plug-element according to claim 20, wherein the plug-element provides a guidance for the locking device for slidably guiding the locking device essentially perpendicularly to a plug-in direction (P) of the plug-element.

24. Electrical plug-element according claim 16, wherein the blocking member is attached pivotable to the plug-element.

25. Electrical plug-element according to claim 16, wherein the blocking member is attached to the plug-element via a slotted link.

26. Electrical plug-element according to claim 16, wherein the blocking member forms an actuating lever for closing the plug-in connector.

27. Electrical plug-element according to claim 16, wherein the blocking member is provided with a latching element adapted to engage with a counter latching element at the plug-element in the blocking position (B).

28. Electrical plug-element according to claim 16, wherein the blocking member is formed as a cover which in the blocking position (B) at least partly covers the cap.

29. Electrical plug-element according to claim 16, wherein the cap has a higher resiliency than the conductor receiving section.

30. Electrical plug-element according to claim 16, wherein the cap has a fitting portion and a conductor guiding section, wherein the fitting portion and the conductor guiding section are angled with respect to each other.
